(19) United States
(12) Patent Application Publication
(10) Pub. No.: US 2017/0012419 A1
(43) Pub. Date: Jan. 12, 2017

(54) HOLDING MEMBER AND RESIN MEMBER PRODUCING DEVICE

(71) Applicant: Yazaki Corporation, Tokyo (JP)

(72) Inventor: Masayoshi Kamenoue, Hiroshima-shi (JP)

(21) Appl. No.: 15/205,897

(22) Filed: Jul. 8, 2016

(30) Foreign Application Priority Data
Jul. 9, 2015 (JP) 2015-137661

(51) Int. Cl. H02G 3/08; B29C 43/02

(52) U.S. Cl. CPC H02G 3/081; B29C 43/021; B29D 99/0007

(57) ABSTRACT

A holding member producing device is provided. A first inclined surface including inward as they separate from a bottom surface is formed on an outer side surface of an arm portion. For this reason, when a first die and a second die having an opening/closing direction which matches with a plate thickness direction of the bottom surface are opened, the locking projections can easily cross over steps by outwardly bending and deforming the arm portions. Therefore, it is possible to suppress damage, projection sizes of locking projections can be increased, and it becomes easy to hold a fuse.

### BACKGROUND

Technical Field

The present invention relates to a resin holding member for holding a held member, and to a holding member producing device for producing a resin member.

Related Art

Generally, in the case of electric connection boxes such as a junction box provided in a car, parts such as a relay, a fuse and a bus bar are accommodated in a case. As such an electric connection box, there is conventionally proposed a box in which a case relay terminal fixing portion is formed, and the box is held by fixing a relay terminal as a held member to the relay terminal fixing portion (see JP 2004-328939 A for example). According the electric connection box described in JP 2004-328939 A, the frame-shaped relay terminal fixing portion projects from a bottom surface on which the relay terminal is placed, and the relay terminal is press-fitted.

Patent Literature 1: JP 2004-328939 A

### SUMMARY

In a case that the held member is fixed by press-fitting as disclosed in JP 2004-328939 A, if an attempt is made to increase a holding force which is caused by the relay terminal fixing portion to restrain the relay terminal from being pulled out, a force required at the time of press-fitting or at the time of detaching becomes large, and operability is lowered. Hence, it is considered to restrain the held member from being pulled out by forming bendable and deformable arm portions on a pair of walls which stand on the bottom surface and sandwich the held member, and by providing locking projections on tip ends of the arm portions, and by sandwiching and holding the held member between the bottom surface and the locking projections.

A case of the electric connection box is generally made of insulative resin. FIGS. 8A and 8B show a procedure for integrally forming, using a pair of dies, a resin case having the above-described arm portions and the locking projections. That is, as shown in FIG. 8A, a first die M10 and a second die M20 are closed to form a cavity, and resin is charged into the cavity, thereby forming a case 10. At this time, the second die M20 includes a pair of concave arm-forming portions M21 which extend along an opening/closing direction of the dies, and concave locking projection-forming portions M22 which extend to approach each other in bottoms of the pair of arm-forming portions M21, and a pair of arm portions 101 and a pair of locking projections 102 are formed. However, as shown in FIG. 8B, when the pair of dies M10 and M20 are separated from each other and opened, it is difficult for the locking projections 102 to cross over steps M23 between the locking projection-forming portions M22 and the arm-forming portions M21, and the locking projections 102 interfere with inner walls of the arm-forming portions M21. Although resin has slight elasticity and can deform, if a projecting size of the locking projection 102 is large, the case is prone to be damaged by interfering with the steps M23. If the projecting size of the locking projection 102 is small on the other hand, it becomes difficult to hold the held member.

It is an object of the present invention to provide a holding member capable of easily holding a held member and capable of suppressing a product from being damaged when the product is pulled out from dies after the product is integrally formed, and to provide a holding member producing device for producing a resin member.

To solve the above issue and achieve the object, the invention according to a first aspect is a holding member made of resin for holding a held member, wherein the holding member includes: a bottom surface on which the held member is placed; and a pair of sandwiching walls which are integrally formed on the bottom surface such that the sandwiching walls stand from the bottom surface, and which sandwich the held member inside, the pair of sandwiching walls include arm portions which can bend and deform in an opposed direction of the sandwiching walls, and locking projections which project inward from tip ends of the arm portions and which lock the held member, and first inclined surfaces which incline inward as they separate from the bottom surface are formed on outer side surfaces of the arm portions.

The invention according to a second aspect is the invention according to the first aspect, further including a pair of side walls which sandwich the held member from a direction intersecting with the opposed direction.

The invention according to a third aspect is the invention according to the first or second aspect, wherein second inclined surfaces which incline outward as they separate from the bottom surface are formed on inner side surfaces of the arm portions.

The invention according to a fourth aspect is the invention according to any one of the first to third aspects, wherein tapered portions which incline such that they separate from the bottom surface as the tapered portions head for inward are formed on surfaces of the locking projections close to the bottom surface.

The invention according to a fifth aspect is a resin member producing device having forming dies for forming a resin member, wherein the forming dies include a first die and a second die which come close to and separate from each other along a predetermined opening/closing direction to close and open the dies, the first die includes a first flat surface extending along a plane which intersects with the opening/closing direction, the second die includes a second flat surface which is opposed to the first flat surface at a distance therefrom in a state where the dies are closed, and a pair of recess grooves extending from the second flat surface along the opening/closing direction, the pair of recess grooves include bottom recesses which are not in communication with each other, and tip end recesses which extend such that they approach each other in bottoms of the bottom recesses, and inclined side surfaces are formed on side surfaces of the bottom recesses which are opposite from the tip end recesses, and the inclined side surfaces incline toward the tip end recesses as the inclined side surfaces separate from the second flat surface.

According to the invention of the first aspect, the pair of sandwiching walls include arm portions which can bend and deform in an opposed direction of the pair of sandwiching walls, and locking projections. Therefore, the holding member can hold the held member by bringing the held member close to the bottom surface while outwardly bending the pair of arm portions, by storing the arm portions, and by making the locking projections lock the held member. Further, first inclined surfaces which incline inward as they separate from the bottom surface are formed on outer side surfaces of the arm portions. Hence, when the holding member is integrally formed by the pair of dies which have a direction intersecting with the bottom surface as the opening/closing direction and when the dies are opened, a gap is formed between the first inclined surface and a surface of the die which forms the first inclined surface. Therefore, the arm portions can outwardly bend and deform when the dies are opened, the locking projection can easily cross over the step between portions of the dies which form the locking projection and portions which form the arm portions, and it is possible to suppress the damage. Further, projection sizes of the locking projections can be increased, and it becomes easy to hold the held member.

According to the invention of the second aspect, the held member is sandwiched not only between the pair of sandwiching walls but also between the pair of side walls, i.e., the held member is surrounded from all directions. Therefore, it is possible to stably hold the held member.

According to the invention of the third aspect, second inclined surfaces which incline outward as they separate from the bottom surface are formed on inner side surfaces of the arm portions. According to this, it becomes easy to open the forming dies. Further, the arm portions can further be tapered (i.e., opposed direction sizes of arm portions can be made smaller as they separate from bottom surface) as compared with a configuration in which only the first inclined surface is formed, and when the dies are opened, tip ends portions of the arm portions can easily bend outward. Therefore, the locking projections can cross over the sandwiching wall-forming portions more easily, and damage can further be suppressed.

According to the invention of the fourth aspect, tapered portions which incline such that as they separate from the bottom surface as the tapered portions head for inward are formed on surfaces of the locking projections close to the bottom surface. According to this, when the pair of dies are opened, surfaces of the dies which form the tapered portions abut against the tapered portions and the surfaces of the dies try to move away from the bottom surface. Therefore, a force acting outward is applied to the locking projections, and it becomes easy for arm portions to bend outward.

According to the invention of the fifth aspect, resin is charged into the cavity formed by the first die and the second die. According to this, the bottom surface is formed between the first flat surface and the second flat surface which are separated from each other, and the pair of side walls are formed by the pair of recess grooves extending from the second bottom surface along the opening/closing direction. Further, the arm portions which can bend and deform are formed by the bottom recesses which are not in communication with each other in the pair of recess grooves, and the locking projections are formed by the tip end recesses which extend such that the locking projections approach each other in the bottoms of the bottom recesses. The inclined side surfaces, which incline toward the tip end recesses as the inclined side surfaces separate from the second flat surface, are formed on the bottom recesses. Therefore, the first inclined surfaces can be formed on the outside of the arm portions. Hence, it is possible to restrain the resin member from being damaged when the dies are opened. Further, the projecting sizes of the locking projections can be increased, and when the formed resin member is used as a holding member which holds the held member, it becomes easy to hold the held member.

### BRIEF DESCRIPTION OF DRAWINGS

FIG. 1 is a perspective view showing a holding member according to an embodiment of the present invention;

FIG. 2 is a sectional view showing the holding member;

FIG. 3 is a side view showing an essential portion of the holding member;

FIGS. 4A and 4B are sectional views showing a procedure to form the holding members by a resin member producing device;

FIG. 5 is a sectional view showing an essential portion of the holding member when dies of the resin member producing device are opened;

FIG. 6 is a sectional view showing a holding member of a modification of the invention;

FIG. 7 is a sectional view showing a holding member of another modification of the invention; and

FIGS. 8A and 8B are sectional views showing a procedure to form a conventional holding member.

### DETAILED DESCRIPTION

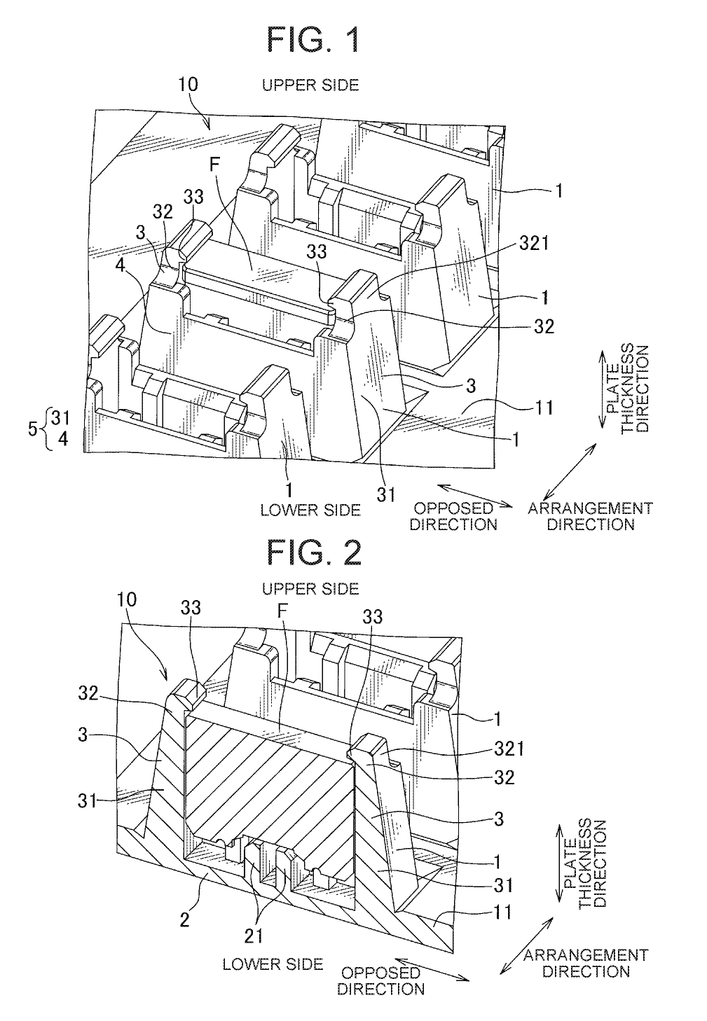

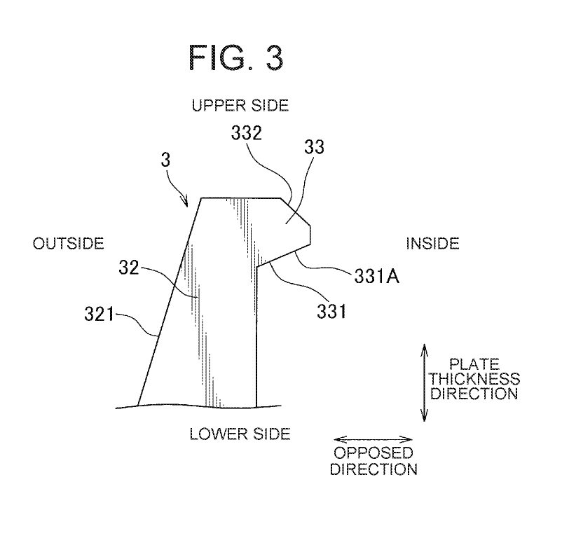

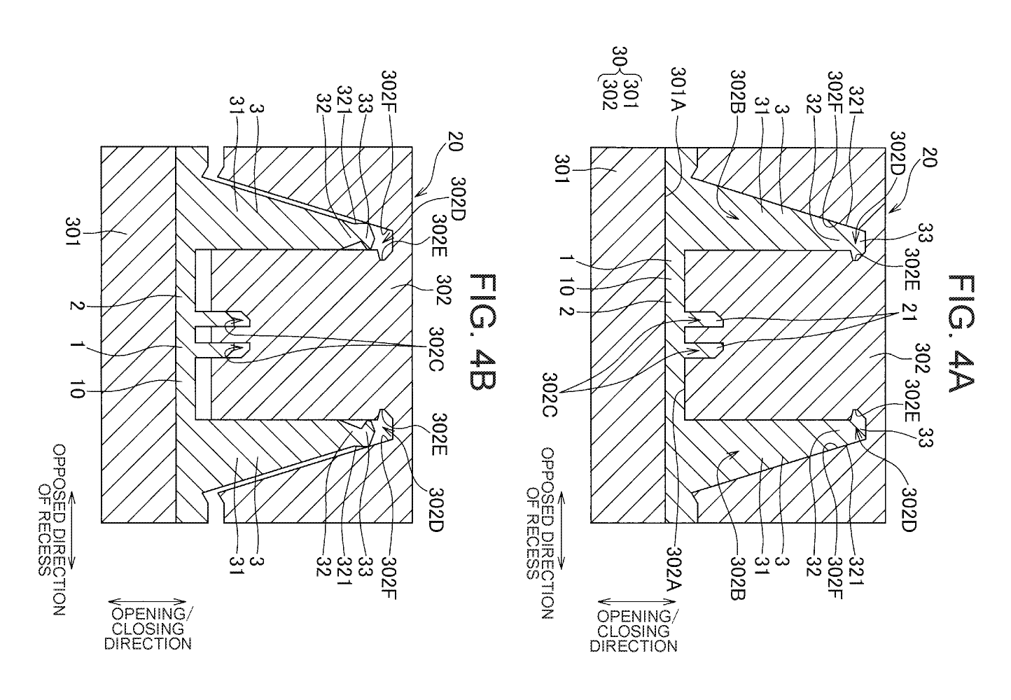

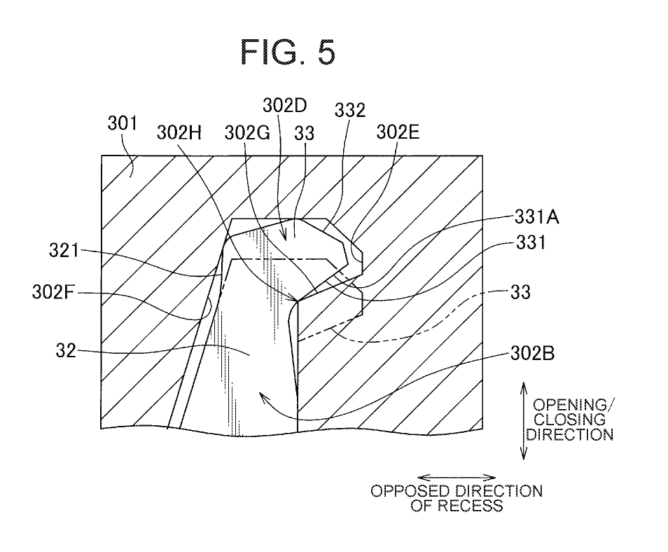

An embodiment of the present invention will be explained based on the drawings below. FIG. 1 is a perspective view showing holding members 1 according to the embodiment of the invention. FIG. 2 is a sectional view showing the holding members 1. FIG. 3 is a side view showing essential portions of the holding members 1. FIGS. 4A and 4B are sectional views showing a procedure to form the holding members 1 by a resin member producing device 20. FIG. 5 is a sectional view showing essential portions of the holding members 1 when dies of the resin member producing device 20 are opened.

As shown in FIGS. 1 and 2, the holding members 1 of the embodiment are provided in a case 10 which accommodates to-be accommodated articles such as a relay, a fuse and a bus bar in an electric connection box provide in a car for example. The holding members 1 are integrally formed with the entire case by resin. The case 10 includes a plate-shaped case body 11 on which the plurality of to-be accommodated articles are placed. The plurality of holding members 1 are arranged on the case body 11 along a predetermined arrangement direction. The holding members 1 are configured to hold an appropriate to-be accommodated article (rectangular parallelepiped fuse F in embodiment) as a held member. Each of the holding members 1 includes a bottom surface 2 which is a portion of the case body 11, a pair of sandwiching walls 3 which stand from the bottom surface 2 and which are opposed to each other in a direction substantially intersecting with the arrangement direction of the holding members 1, and a pair of side walls 4 which stand from the bottom surface 2 and which are opposed to each other along the arrangement direction. In this embodiment, a direction substantially intersecting with the bottom surface 2 is called a “plate thickness direction”, the arrangement direction of the holding members 1 is called an “arrangement direction”, and the opposed direction of the pair of sandwiching walls 3 is called an “opposed direction”. Locations on the side of the sandwiching walls 3 and the side walls 4 on the basis of the bottom surface 2 is called an “upper side”, and a side opposite from the upper side is called a “lower side”.

The fuse F is placed on the bottom surface 2, and includes a projecting placing portion 21 which projects upward in a substantially central portion of the opposed direction. The projecting placing portion 21 abuts against a bottom surface of the fuse F.

The pair of sandwiching walls 3 sandwich the fuse F inside (between pair of sandwiching walls 3). A distance between the sandwiching walls 3 is substantially equal to or slightly larger than the opposed direction size of the fuse F. Each of the sandwiching walls 3 includes a wall body 31 having both ends in the arrangement direction which are integrally formed on the side wall 4, an arm portion 32 which is connected to an upper end of the wall body 31 and which can bend and deform in the opposed direction, and a locking projection 33 which projects inward from the tip end of the arm portion 32 and which locks the fuse F. An outer side surface of each of the sandwiching walls 3 inclines inward as separating from the bottom surface 2, and a first inclined surface 321 is formed on an entire outer side surface of the arm portion 32. It is only necessary to set an inclination angle with respect to a plate thickness direction of the first inclined surface 321 in accordance with a projection side of the locking projection 33 for example. It is preferable that as the projection size is larger, the inclination angle is larger. An inner side surface of the sandwiching wall 3 extends along the plate thickness direction.

The locking projections 33 lock and hold the fuse F by sandwiching the fuse F between lower surfaces 331 on the side of the bottom surface 2 and the bottom surface 2. As shown in FIG. 3, each of the lower surfaces 331 inclines upward (separating from bottom surface 2) as heading for inward, and tapered portions 331A are formed on the entire lower surfaces 331. An upper surface tapered portion 332, which inclines downward as heading for inward, is formed near a tip end of an upper surface of the locking projection 33. A separating distance between the pair of locking projections 33 is smaller than an opposed direction size of the fuse F.

Insides of the pair of side walls 4 sandwich the fuse F (between pair of side walls 4), and have a separating distance which is substantially equal to or slightly larger than an arrangement direction size of the fuse F. The side walls 4 and the wall bodies 31 are integrally formed in both ends in the opposed direction, and a rectangular cylindrical frame 5 is composed of the pair of wall bodies 31 and the pair of side walls 4. The fuse F is surrounded by the frame 5 from all directions. A slit may be formed between the wall body 31 and the side wall, and portions or the entire of the wall bodies 31 and the side walls 4 may not integrally be formed together.

States of various portions when the holding members 1 hold the fuse F will be described. A position of the fuse F is adjusted such that it is located on an inner side of the frame 5, and the fuse F is made to approach the bottom surface 2 along the plate thickness direction. If a bottom surface of the fuse F abuts against an upper surface tapered portion 332 of the locking projection 33, a force acting outward in the opposed direction is applied to the locking projections 33, the arm portions 32 bend outward and the fuse F can pass between the pair of locking projections 33. If the bottom surface of the fuse F abuts against the projecting placing portion 21, a ceiling surface of the fuse F is located lower than the locking projections 33, and the arm portions 32 restore and the locking projections 33 lock the ceiling surface of the fuse F. The fuse F may project up to a side higher than the sandwiching walls 3, the locking projections 33 enter recesses formed in the side surface of the fuse F, and the locking projections 33 may lock the fuse F.

A resin member producing device 20 which forms the case 10 provided with the holding members 1 as resin members will be described below. As shown in FIGS. 4A and 4B, the resin member producing device 20 includes a forming die 30 having a first die 301 and a second die 302 both made of metal, and a moving means (not shown). The moving means closes and opens the dies by moving the first die 301 and the second die 302 in an approaching direction and a separating direction.

The first die 301 includes a first flat surface 301A extending along a plane substantially intersecting with the opening/closing direction at right angles. The second die 302 includes a second flat surface 302A which is separated from and opposed to the first flat surface 301A in a die-closed state and which extends substantially parallel to the first fiat surface 301A, a pair of sandwiching wall-forming portions 302B as a pair of recess grooves extending from the second flat surface 302A along the opening/closing direction, a pair of side wall-forming portions (not shown) extending from the second flat surface 302A along the opening/closing direction, and placement forming portions 302C extending from the second flat surface 302A along the opening/closing direction. The sandwiching wall-forming portions 302B, the side wall-forming portions and the placement forming portions 302C are formed into recess forms such that they separate from the first flat surface 301A. The pair of sandwiching wall-forming portions 302B are in communication with the side wall-forming portions on both ends (front side end and deep side end in the paper sheet of FIGS. 4A and 4B) in a direction substantially intersecting with mutual opposed direction (recess opposed direction, hereinafter). That is, a substantially rectangular annular recess is formed in the second flat surface 302A as viewed from the first flat surface 301A. A depth of the pair of side wall-forming portions is shallower than that of the sandwiching wall-forming portions 302B, and bottoms of the pair of sandwiching wall-forming portions 302B are not in communication with each other. The non-communication portions become arm-forming portions 302D as bottom recesses.

Locking projection-forming portions 302E as tip end recesses are formed on the pair of sandwiching wall-forming portions 302B. The locking projection-forming portions 302E extend inward (between pair of arm-forming portions 302D) such that they approach each other in bottoms of the arm-forming portions 302D. Inclined side surfaces 302F which incline such that they approach each other (toward locking projection-forming portions 302E) as they separate from the second flat surface 302A.

A method for forming the case 10 provided with the holding members 1 using such a resin member producing device 20 will be described. First, the first and second dies 301 and 302 are made to approach each other to close the dies by the moving means to form a cavity. Resin is charged into the cavity and is hardened, thereby forming the case 10. That is, a portion sandwiched between the first flat surface 301A and the second flat surface 302A becomes the bottom surfaces, and the wall bodies 31 of the sandwiching walls 3 are formed by portions of the sandwiching wall-forming portions 302B which are in communication with the side wall-forming portions. The side wall 4 is formed by the side wall-forming portions, and the projecting placing portions 21 are formed by the placement forming portions 302C. Further, the locking projections 33 are formed on tip ends of the arm portions 32 by the locking projection-forming portions 302E, and the first inclined surfaces 321 are formed outside of the arm portions 32 by the inclined side surfaces 302F. Therefore, the opening/closing direction and the plate thickness direction match with each other, and the recess opposed direction and the opposed direction match with each other.

Next, the first die 301 and the second die 302 are separated by the moving means to open the dies. A state around the arm portions 32 at that time will be described with reference also to FIG. 5. The lower surface 331 of the locking projection 33 and a lower surface-forming portion 302G, which forms the lower surface 331 of the locking projection-forming portion 302E, abut against each other in the opening/closing direction so that the dies are restrained from opening. By separating the first die 301 and the second die 302 from each other by such a force that resin is not plastically deformed, the holding members 1 are resiliently deformed. More specifically, an angle portion of a step 302H between the sandwiching wall-forming portions 302B and the locking projection-forming portions 302E is jammed into the lower surface 331 of the locking projection 33.

If the holding members 1 are deformed and the second die 302 is separated from the first die 301, gaps are formed between the first inclined surfaces 321 and the inclined side surfaces 302F which are outer side surfaces of the arm portions 32. Since the tapered portions 331A are formed on the lower surfaces 331, an outward force is applied to the locking projection 33, and the arm portions 32 are bent and deformed outward. If the second die 302 is further separated from the first die 301, the gaps between the first inclined surfaces 321 and the inclined side surfaces 302F become large, and the angle portion of the step 302H slides with the lower surface 331, and the arm portions 32 are further bent outward. At this time, each of the entire locking projections 33 may be bent and deformed in a convex form toward a direction separating from the angle portion of the step 302H. Further, the arm portions 32 and the locking projections 33 may appropriately shrink and extend by elasticity of the resin.

By bending the arm portions 32 outward or by extending and shrinking the arm portions 32 by elasticity of resin, the tip ends (innermost portions) of the locking projections 33 cross over the step 302H, and the tip ends can pass through the sandwiching wall-forming portions 302B. If the die-opening operation is completed, the case 10 is detached from the resin member producing device 20, and the forming operation is completed.

According to the embodiment, the following effects can be obtained. That is, the first inclined surface 321 which inclines inward as it separates from the bottom surface 2 is formed on the outer side surface of each of the arm portions 32, the arm portions 32 bend and deform outward and the locking projection 33 can easily cross over the step 302H when the dies are opened after the holding members 1 are integrally formed by the first die 301 and the second die 302 such that the direction which matches with the plate thickness direction of the bottom surface 2 is the opening/closing direction. Therefore, it is possible to suppress the damage, the projection sizes of the locking projections 33 are increased, and it becomes easy to hold the fuse F.

Since the tapered portions 331A are formed on the lower surfaces 331 of the locking projections 33, it becomes easy to bend the arm portions 32 outward when the dies are opened.

The holding members 1 are formed into rectangular cylindrical forms by the pair of wall bodies 31 and the pair of side walls 4 and the fuse F includes the frame 5 which surrounds the fuse F from all directions. Therefore, it is possible to stably hold the fuse F.

The invention is not limited to the embodiment, and includes other configurations which can achieve the object of the invention, and the following deformations are also included in the invention.

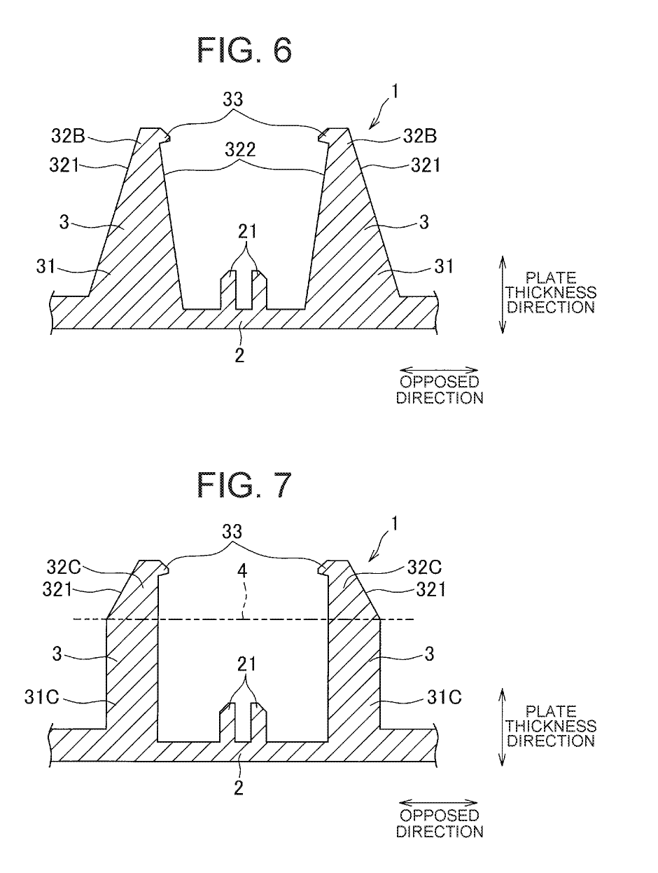

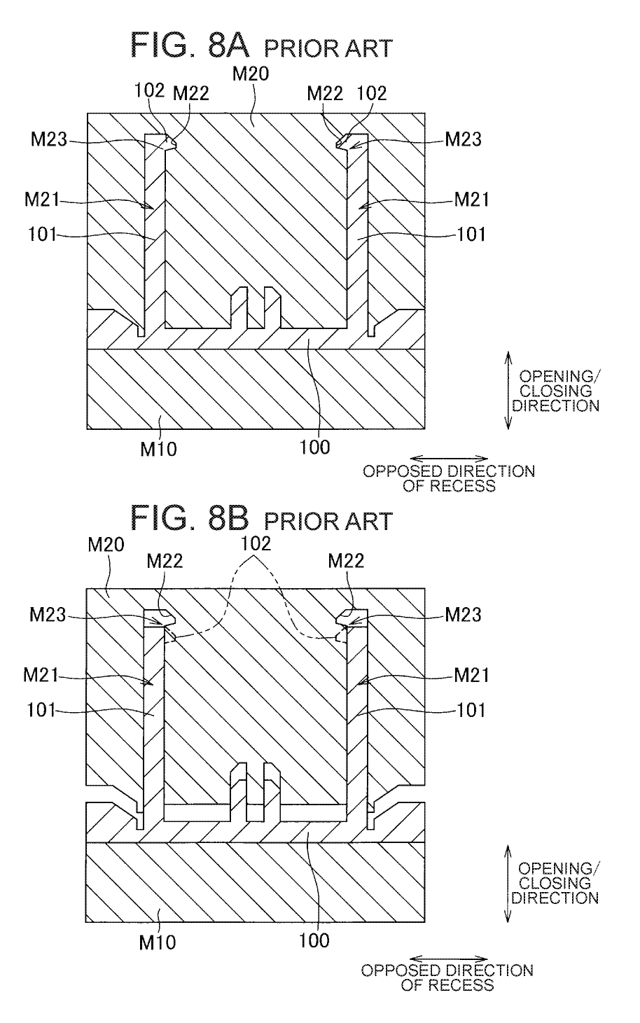

For example, the inner side surfaces of the sandwiching walls 3 extend along the plate thickness direction in the embodiment. Alternatively, as shown in FIG. 6, second inclined surfaces 322 may be formed on inner side surfaces of arm portions 32B by inclining inner side surfaces of the sandwiching walls 3 such that they are oriented outward as they separate from the bottom surface 2. According to such a configuration, it is possible to make it easy to open the forming dies. Further, the arm portions 32B can further be tapered (i.e., opposed direction sizes of arm portions 32B can be made smaller as they separate from bottom surface 2) as compared with a configuration in which only the first inclined surface 321 is formed, and when the dies are opened, tip ends portions of the arm portions 32B can easily bend outward. Therefore, the locking projections 33 can cross over the sandwiching wall-forming portions 302B more easily, and damage can further be suppressed. The inner side surfaces of the wall bodies 31 may not incline and may extend along the plate thickness direction, and the second inclined surfaces may be formed only on the arm portions 32B.

Although the first inclined surface 321 is formed on the outer side surface of each of the arm portions 32 by inclining the entire outer side surface of the sandwiching wall 3 in the embodiment, the outer side surface of the wall body 31C may not incline and may extend along the plate thickness direction as shown in FIG. 7. That is, only outer side surfaces of arm portions 32C provided at locations higher than an upper end of the side wall 4 (shown by phantom line) may incline. It is unnecessary that the first inclined surface may not be formed on the entire outer side surface of the arm portion, and the first inclined surface may be formed in an appropriate range of the outer side surface so that a sufficient gap is formed between the first inclined surface and an inclined side surface 302F when the dies are opened.

In the embodiment, the pair of side walls 4 are opposed to the arrangement direction of the plurality of holding members 1 in the case 10, and the pair of sandwiching walls 3 are opposed to the direction which substantially intersects with the arrangement direction. Alternatively, it is possible to employ configurations that the opposed direction of the pair of sandwiching walls 3 and the opposed direction of the pair of side walls 4 intersect with each other, and a relation between the opposed direction and the arrangement direction is not limited. The pair of side walls 4 may be omitted, and the holding members may sandwich the held member from one direction by the pair of sandwiching walls 3.

Although the tapered portion 331A is formed on the entire lower surface 331 of the locking projection 33 in the embodiment, it is only necessary that the tapered portion 331A is formed such that a sufficient force to bent the arm portions 32 outward is generated, and the tapered portion 331A may be formed in an appropriate range of the lower surface 331 in accordance with the inclination angle for example. When the holding members 1 are easily deformed and the arm portions 32 can easily and sufficiently bend outward when the dies are opened, the tapered portion 331A may not be formed on the lower surface 331.

Although the best configuration and method to carry out the invention are disclosed above, the invention is not limited to them. That is, especially the specific embodiment is mainly shown in the drawings and described, and a person skilled in the art can variously modify the embodiment without departing from the technical idea and the range of the object in terms of the shape, the material, the numerical quantity and other detailed configurations. Therefore, the descriptions which define the shape, the material and the like disclosed above are shown as examples to facilitate understanding of the invention, and these descriptions do not limit the invention. Therefore, descriptions of the names of the members from which a portion of definition such as the shape and the material or all of the definitions are removed are included in the invention.

### REFERENCE SIGNS LIST

1 holding member (resin member)
2 bottom surface
3 sandwiching wall
4 side wall
21 arm portion
22 locking projection
321 first inclined surface
322 second inclined surface
331 lower surface
331A tapered portion
20 resin member producing device
30 forming die
301 first die
302 second die
301A first flat surface
302A second fiat surface
302B sandwiching wall-forming portion (recess groove)
302D arm-forming portion (bottom recess)
302E locking projection-forming portion (tip end recess)
302F inclined side surface
F fuse (held member)

What is claimed is:

1. A holding member made of resin for holding a held member comprising:
a bottom surface on which the held member is placed; and
a pair of sandwiching walls which are integrally formed on the bottom surface such that the sandwiching walls stand from the bottom surface, and which sandwich the held member inside,
wherein each of the pair of sandwiching walls includes an arm portion which can bend and deform in an opposed direction of the sandwiching walls, and a locking projection which projects inward from a tip end of the arm portion and which lock the held member, and
wherein a first inclined surface which inclines inward as separating from the bottom surface is formed on an outer side surface of the arm portion.

2. The holding member according to claim 1, further comprising a pair of side walls which sandwich the held member from a direction intersecting with the opposed direction.

3. The holding member according to claim 1, wherein a second inclined surface is formed on an inner side surface of the arm portion, the second inclined surface inclining outward as separating from the bottom surface.

4. The holding member according to claim 1, wherein a tapered portion is formed on a surface of the locking projection at a bottom surface side, the tapered portion being inclined away from the bottom surface toward an inside.

5. A resin member producing device comprising:
a forming die for forming a resin member,
wherein the forming die include a first die and a second die which come close to and separate from each other along a predetermined opening/closing direction to close and open the die,
wherein the first die includes a first flat surface extending along a plane which intersects with the opening/closing direction,
wherein the second die includes a second flat surface which is opposed to the first flat surface at a distance therefrom in a state where the dies are closed, and a pair of recess grooves extending from the second flat surface along the opening/closing direction,
wherein the pair of recess grooves include a bottom recess which is not in communication with each other, and a tip end recess which extends such that they approach each other in bottoms of the bottom recess, and
wherein an inclined side surface is formed on side surfaces of the bottom recess which is opposite from the tip end recess, and the inclined side surface inclines toward the tip end recess as the inclined side surface separates from the second flat surface.

6. The holding member according to claim 2, wherein a second inclined surface is formed on an inner side surface of the arm portion, the second inclined surface inclining outward as separating from the bottom surface.

7. The holding member according to claim 2, wherein a tapered portion is formed on a surface of the locking projection at a bottom surface side, the tapered portion being inclined away from the bottom surface toward an inside.

8. The holding member according to claim 3, wherein a tapered portion is formed on a surface of the locking projection at a bottom surface side, the tapered portion being inclined away from the bottom surface toward an inside.

9. The holding member according to claim 6, wherein a tapered portion is formed on a surface of the locking projection at a bottom surface side, the tapered portion being inclined away from the bottom surface toward an inside.
